(19) United States
(12) Patent Application Publication
(10) Pub. No.: US 2026/0295817 A1
(43) Pub. Date: Oct. 1, 2026

(54) GRIPPER MECHANISM, ROBOTIC ARM, AND GRIPPING FORCE CONTROL METHOD

(71) Applicant: Suzhou Xinghaitu Dynamics Technology Co., Ltd., Suzhou (CN)

(72) Inventor: Zeyi YANG, Suzhou (CN)

(21) Appl. No.: 19/630,601

(22) Filed: Mar. 27, 2026

(30) Foreign Application Priority Data
Mar. 27, 2025 (CN) 202510370966.2

(51) Int. Cl. B25J 9/16; B25J 15/02

(52) U.S. Cl. CPC B25J 9/1612; B25J 9/1633; B25J 15/026

(57) ABSTRACT

A gripper mechanism includes a securing base, a driving assembly, and two grippers. The securing base is provided with two sliding grooves that are spaced apart along a first direction and both extend along a second direction. The driving assembly includes a motor, a rotary base, multiple engaging members, and two racks. The motor is configured to drive the rotary base to rotate, the multiple engaging members are uniformly spaced apart along a circumference on one side of the rotary base, the two racks are slidably inserted in the sliding grooves respectively, sides of the two racks facing each other are each provided with multiple driving slots, and two of the multiple engaging members on both sides of the rotary base along the first direction respectively engage with two of the plurality of driving slots.

### CROSS-REFERENCE TO RELATED APPLICATION(S)

This application claims priority to Chinese Patent Application No. 202510370966.2 filed Mar. 27, 2025, the disclosure of which is incorporated herein by reference in its entirety.

### TECHNICAL FIELD

The present disclosure relates to the technical field of intelligent manufacturing and, in particular, to a gripper mechanism, a robotic arm, and a gripping force control method.

### BACKGROUND

In the field of industrial automation, robots and robotic arms have been increasingly applied. An end effector mounted at a tail end of a robot/robotic arm can control the opening and closing of grippers by driving gears and racks through the rotation of a motor, thereby gripping an object. However, such an end effector also presents some evident disadvantages.

Although a gear-and-rack transmission mechanism has a relatively simple structure, a gear has a relatively large radial size. This results in the gear-and-rack transmission mechanism requiring a relatively large space in the radial direction of the gear, thereby increasing the size of the end effector.

### SUMMARY

In view of the preceding, the present disclosure provides a gripper mechanism, a robotic arm, and a gripping force control method, in which engaging members, a rotary base, and a motor are stacked along an axial direction of the rotary base, thereby reducing the size of the gripper mechanism along a radial direction of the rotary base and making the structure more compact.

The present disclosure provides the technical solutions below.

In a first aspect, a gripper mechanism is provided. The gripper mechanism includes a securing base, a driving assembly, and two grippers.

The securing base is provided with two sliding grooves that are spaced apart along a first direction and both extend along a second direction.

The driving assembly includes a motor, a rotary base, multiple engaging members, and two racks, where the motor is configured to drive the rotary base to rotate, the multiple engaging members are uniformly spaced apart along a circumference on one side of the rotary base facing away from the motor, the two racks are slidably inserted in the two sliding grooves respectively, sides of the two racks facing each other are each provided with multiple driving slots spaced apart, and at least two of the multiple engaging members on both sides of the rotary base along the first direction respectively engage with at least two of the multiple driving slots that are respectively arranged on the two racks.

The two grippers are respectively connected to the two racks to enable the rotary base to drive the two grippers to move toward or away from each other along the second direction when the rotary base rotates.

In some embodiments, each of the multiple engaging members is a follower bearing that is detachably connected to the rotary base and is configured to roll on an inner wall of a respective driving slot to be engaged with the respective driving slot.

In some embodiments, the gripper mechanism further includes two adapter blocks, where each of the two grippers is connected to a respective rack through a respective adapter block; each of the two adapter blocks includes a first connecting portion and a second connecting portion that are spaced apart along the first direction, the first connecting portion is connected to a middle position of a respective gripper along the first direction, the second connecting portion is connected to a respective rack, and the two grippers are opposite to each other along the second direction.

In some embodiments, each of the two racks is provided with a positioning groove, the second connecting portion of each of the two adapter blocks is provided with a positioning protrusion configured to be embedded into a respective positioning groove; or

In some embodiments, the second connecting portion of each of the two adapter blocks is provided with a positioning groove, each of the two racks is provided with a positioning protrusion configured to be embedded into a respective positioning groove.

In some embodiments, the gripper mechanism further includes a cover plate. The cover plate is detachably connected to the securing base, a sidewall of each of the two racks is provided with a flange, a bottom of each of the two sliding grooves is provided with a first clearance hole, the cover plate is provided with second clearance holes, and the flange of each of the two racks is located between a bottom of a respective sliding groove and a lower surface of the cover plate; one end of each of the two racks provided with the multiple driving slots penetrates through a respective first clearance hole, and another end of each of the two racks facing away from the multiple driving slots penetrates through a respective second clearance hole.

In some embodiments, one side of the securing base facing away from the cover plate is provided with an accommodating chamber, an end of each of the two racks provided with the multiple driving slots penetrates through a respective first clearance hole and is located within the accommodating chamber, the rotary base and the multiple engaging members are located within the accommodating chamber, and the motor is connected to a side of the securing base facing away from the cover plate.

In some embodiments, the securing base is provided with an edge groove extending along a circumferential direction of the securing base, the cover plate is provided with an edge boss corresponding to the edge groove, and the edge boss is configured to be embedded into the edge groove.

In some embodiments, a flange plate is detachably mounted at one end of the motor facing away from the rotary base.

In a second aspect, a robotic arm is provided. The robotic arm includes a robotic arm body and the gripper mechanism of any one of the preceding solutions, where the gripper mechanism is disposed at a tail end of the robotic arm body.

In a third aspect, a gripping force control method is provided. The method uses the gripper mechanism of any one of the preceding solutions and includes the steps below.

S1, setting a required gripping force for the two grippers.

S2, calculating a required torque of the motor by the following formula:

$$A ( α ) = ⌊ ( \frac{N ( α - {α}_{offset} )}{2 π} + \frac{1}{2} ) ⌋$$

$$τ ( α , F ) = FR cos ( \frac{π}{N} - A \times \frac{2 π}{N} + α - {α}_{offset} ) )$$

where τ denotes the required torque of the motor, F denotes the required gripping force for the two grippers, R denotes a radius of a circle on which the multiple engaging members are arranged, A denotes a serial number of an engaging member of the multiple engaging members that drives a rack of the two racks to move, α_{offset} denotes an offset radian between a connection line from an axis of a first engaging member to an axis of the motor and the first direction when the two grippers are in a closed state, and α denotes a rotation radian of the motor relative to α_{offset}.

S3, controlling a current magnitude of the motor to enable the motor to reach the required torque.

The present disclosure provides the gripper mechanism, the robotic arm, and the gripping force control method. During operation, the motor drives the rotary base to rotate, the rotary base drives the multiple engaging members to rotate, and the engaging members engage with the two racks for transmission so as to enable the two racks to move toward or away from each other along the second direction within the sliding grooves, thereby enabling the two grippers to grip or release an object. In the present disclosure, the engaging members, the rotary base, and the motor are stacked along an axial direction of the rotary base, thereby reducing the size of the gripper mechanism along a radial direction of the rotary base and making the structure more compact.

Moreover, when the grippers grip an object, the required torque of the motor is calculated according to the rotation radian of the motor at that time and the required gripping force, and then the current of the motor is adjusted so that the motor can reach the required torque, thereby ensuring that the grippers can grip objects of different sizes with a constant force and improving the performance of the gripper mechanism.

### BRIEF DESCRIPTION OF DRAWINGS

To illustrate technical solutions in embodiments of the present disclosure more clearly, drawings used in the description of the embodiments of the present disclosure are briefly described below. Apparently, the drawings described below illustrate only part of the embodiments of the present disclosure, and those of ordinary skill in the art may obtain other drawings based on the content of the embodiments of the present disclosure and the drawings on the premise that no creative work is done.

FIG. 1 is a structural view of a gripper mechanism according to a specific embodiment of the present disclosure.

FIG. 2 is an exploded view of a gripper mechanism according to a specific embodiment of the present disclosure.

FIG. 3 is a structural view of a securing base according to a specific embodiment of the present disclosure.

FIG. 4 is a structural view of a driving assembly according to a specific embodiment of the present disclosure.

FIG. 5 is an exploded view of a driving assembly according to a specific embodiment of the present disclosure.

### REFERENCE LIST

1 securing base
12 accommodating chamber
13 first clearance hole
14 edge groove
15 third threaded hole
2 driving assembly
21 motor
211 first positioning hole
22 rotary base
22 second positioning hole
23 engaging member
24 rack
241 positioning groove
242 flange
243 driving slot
244 first threaded hole
25 adapter block
251 first connecting portion
2511 second threaded hole
252 second connecting portion
2521 positioning protrusion
2522 first through hole
3 gripper
4 cover plate
41 second clearance hole
42 edge boss
43 countersunk hole
5 flange plate
51 connecting groove

### DETAILED DESCRIPTION

The present disclosure is further described in detail hereinafter in conjunction with the drawings and embodiments. It is to be understood that the embodiments described herein are intended to explain the present disclosure and not to limit the present disclosure. Additionally, it is to be noted that for ease of description, part, not all, of the structures related to the present disclosure are illustrated in the drawings.

In the description of the present disclosure, terms “joined”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relationships indicated by terms “above”, “below”, “left”, “right”, and the like are based on the drawings. These orientations or position relationships are for ease of description and simplifying an operation and do not indicate or imply that a referred apparatus or element must have a specific orientation and must be constructed and operated in a specific orientation. Thus, these orientations or position relationships are not to be construed as limiting the present disclosure. Additionally, terms “first” and “second” are used only for the distinguishing purpose and have no special meanings.

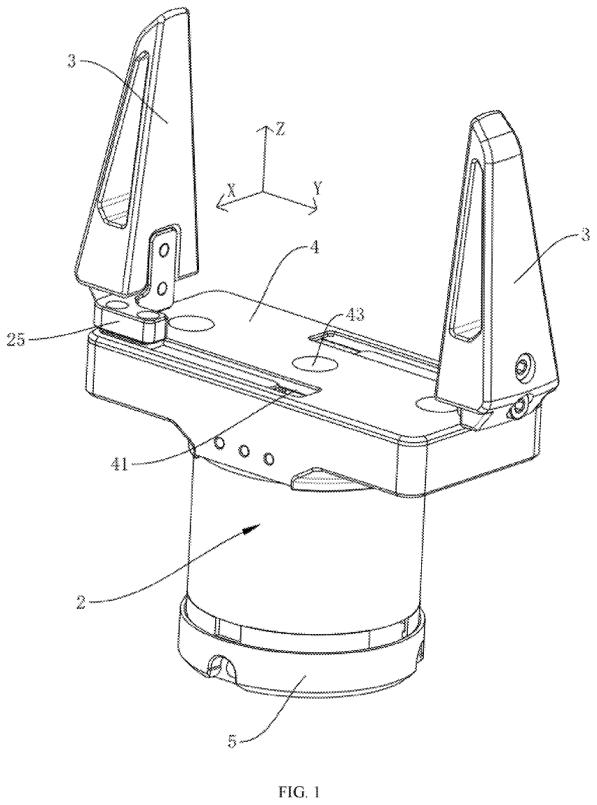

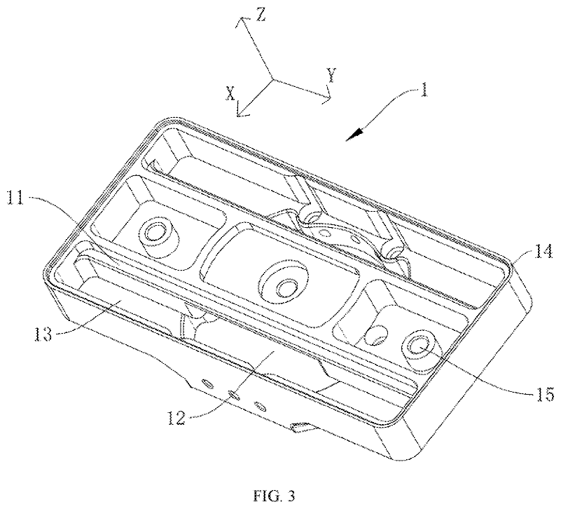

As shown in FIGS. 1 to 3, this embodiment provides a robotic arm. The robotic arm includes a robotic arm body and a gripper mechanism, and the gripper mechanism is disposed at a tail end of the robotic arm body. The gripper mechanism includes a securing base 1, a driving assembly 2, and two grippers 3. The securing base 1 is provided with two sliding grooves 11 that are spaced apart along a first direction and both extend along a second direction. The driving assembly 2 includes a motor 21, a rotary base 22, multiple engaging members 23, and two racks 24. The motor 21 is configured to drive the rotary base 22 to rotate, the multiple engaging members 23 are uniformly spaced apart along the circumference on one side of the rotary base 22 facing away from the motor 21, the two racks 24 are slidably inserted in the two sliding grooves 11 respectively, the sides of each of the two racks 24 facing each other is provided with multiple driving slots 243 spaced apart along the second direction, and the multiple engaging members 23 on both sides of the rotary base 22 along the first direction respectively engage with two of the multiple driving slots 243 that are respectively arranged on the two racks 24. The two grippers 3 are respectively connected to the two racks 24 to enable the rotary base 22 to drive the two grippers 3 to move toward or away from each other along the second direction when the rotary base 22 rotates. In this embodiment, the first direction is X, the second direction is Y, and a third direction is Z, and the first direction, the second direction, and the third direction are mutually orthogonal.

During operation, the motor 21 drives the rotary base 22 to rotate, the rotary base 22 drives the multiple engaging members 23 to rotate, and the engaging members 23 engage with the two racks 24 for transmission so as to enable the two racks 24 to move toward or away from each other along the second direction within the sliding grooves 11, thereby enabling the two grippers 3 to grip or release an object. In this embodiment, the engaging members 23, the rotary base 22, and the motor 21 are stacked along an axial direction of the rotary base 22, thereby reducing the size of the gripper mechanism along a radial direction of the rotary base 22 and making the structure more compact.

In the related art, under long-term high-load operation, wear on gears and deformation of the racks 24 in a conventional gripper mechanism may lead to a decreased transmission precision, thereby adversely affecting the gripping stability and accuracy of the grippers 3. Preferably, each of the multiple engaging members 23 is a follower bearing that is detachably connected to the rotary base 22 and is configured to roll on an inner wall of a respective driving slot 243 to be engaged with the respective driving slot 243. By adopting the follower bearings, a higher load capacity and lower friction are achieved, thereby significantly reducing friction loss, improving transmission efficiency, prolonging the service life of the gripper mechanism, and enhancing stability.

Preferably, the rotary base 22 has a centrosymmetric structure, and an even number of rolling bearings are evenly distributed along the circumferential direction of the rotary base 22. During rotation of the rotary base 22, the two racks 24 move in opposite directions or in the same direction at the same speed, thereby achieving a parallel motion effect. In this embodiment, eight rolling bearings are provided and are threadedly connected to the rotary base 22. Four rolling bearings drive one rack 24, and the other four rolling bearings drive the other rack 24.

Since the two racks 24 are located on both sides of the rotary base 22 along the first direction, preferably, the gripper mechanism further includes two adapter blocks 25. Each of the two grippers 3 is connected to a respective rack 24 through a respective adapter block 25. Each of the two adapter blocks 25 includes a first connecting portion 251 and a second connecting portion 252 that are spaced apart along the first direction. The first connecting portion 251 is connected to a middle position of a respective gripper 3 along the first direction, the second connecting portion 252 is connected to a respective rack 24, and the two grippers 3 are arranged opposite to each other along the second direction. By providing the adapter blocks 25, force points of the grippers 3 are located at the middle positions of the grippers 3 along the first direction, and the force points of the two grippers 3 are arranged opposite to each other along the second direction so that the gripping force can act on the object to the maximum extent, thereby ensuring the reliability of gripping the object. In this embodiment, the first connecting portion 251 extends along the third direction, and the second connecting portion 252 extends along the second direction. A connecting portion extending along the first direction is provided between the first connecting portion 251 and the second connecting portion 252. The projections of the adapter blocks 25 along the first direction, the second direction, and the third direction are all L-shaped.

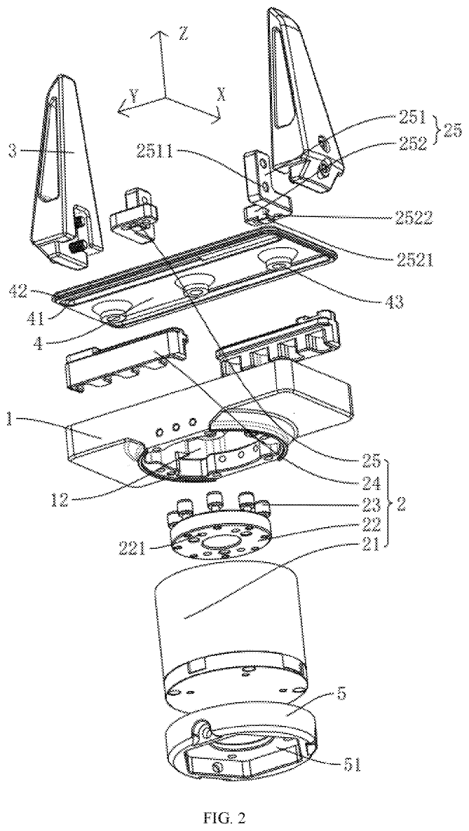

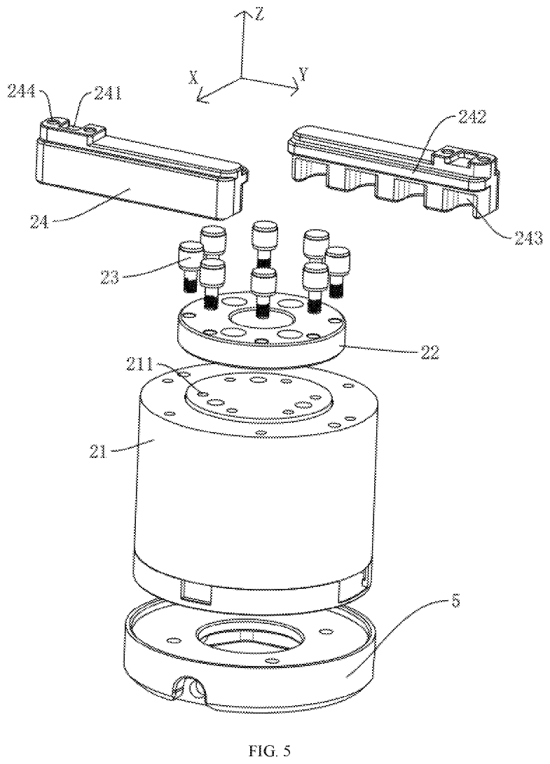

As shown in FIGS. 2 and 5, in this embodiment, for the racks 24 and the second connecting portions 252, one of a rack 24 or a second connecting portion 252 is formed with a positioning groove 241, and the other one of the rack 24 or the second connecting portion 252 is provided with a positioning protrusion 2521. The positioning protrusion 2521 can be embedded into the positioning groove 241, thereby improving the assembly precision between the racks 24 and the adapter blocks 25. In this embodiment, the second connecting portion 252 is formed with the positioning protrusion 2521, and the rack 24 is provided with the positioning groove 241. Further, the second connecting portion 252 is provided with two first through holes 2522 that are located on both sides of the positioning groove 241, and the rack 24 is provided with two first threaded holes 244. First screws penetrate through the first through holes 2522 and are threadedly connected to the first threaded holes 244 respectively, thereby connecting the second connecting portion 252 to the rack 24. The first connecting portion 251 is provided with two second threaded holes 2511, and a gripper 3 is provided with two second through holes. Second screws penetrate through the second through holes and are threadedly connected to the second threaded holes 2511 respectively, thereby connecting the first connecting portion 251 to the gripper 3. The gripper 3 is detachably connected to the first connecting portion 251, so as to facilitate replacement of the gripper 3 to meet production requirements.

In this embodiment, when two adjacent follower bearings are switched, the rack 24 keeps engaging with two engaging members 23, ensuring effective switching of adjacent engaging members 23.

In this embodiment, as shown in FIGS. 2 to 5, the gripper mechanism further includes a cover plate 4, the cover plate 4 is detachably connected to the securing base 1, a sidewall of each of the two racks 24 is provided with a flange 242, a bottom of each of the two sliding grooves 11 is provided with a first clearance hole 13, the cover plate 4 is provided with second clearance holes 41, and the flange 242 of each of the two racks 24 is located between a bottom of a respective sliding groove 11 and a lower surface of the cover plate 4; one end of each of the two racks 24 provided with the multiple driving slots 243 penetrates through a respective first clearance hole 13, and another end of each of the two racks 24 facing away from the multiple driving slots 243 penetrates through a respective second clearance hole 41. During assembly, the ends of the racks 24 each provided with the driving slots 243 penetrate through the first clearance holes 13, and the flanges 242 overlap the bottoms of the sliding grooves 11. The cover plate 4 is then connected to the securing base 1. In this case, the other ends of the racks 24 each facing away from the driving slots 243 penetrate through the second clearance holes 41, and end faces of the second clearance holes 41 are pressed against the flanges 242, thereby securing the racks 24 within the sliding grooves 11. Moreover, the first clearance holes 13 and the second clearance holes 41 do not interfere with the movements of the racks 24 along the second direction.

In this embodiment, the cover plate 4 is provided with three countersunk holes 43, and the securing base 1 is provided with three third threaded holes 15. Screws penetrate through the countersunk holes 43 and are threadedly connected to the third threaded holes 15, thereby detachably connecting the cover plate 4 to the securing base 1.

Preferably, the securing base 1 is formed with an edge groove 14 extending along a circumferential direction of the securing base 1, and the cover plate 4 is provided with an edge boss 42 corresponding to the edge groove 14. The edge boss 42 can be embedded into the edge groove 14, thereby improving the connection precision between the cover plate 4 and the securing base 1 and enhancing assembly convenience.

Further, one side of the securing base 1 facing away from the cover plate 4 is provided with an accommodating chamber 12, an end of each of the two racks 24 provided with the multiple driving slots 243 penetrates through a respective first clearance hole 13 and is located within the accommodating chamber 12, the rotary base 22 and the engaging members 23 are located within the accommodating chamber 12, and the motor 21 is connected to the side of the securing base 1 facing away from the cover plate 4. In this embodiment, one side of the accommodating chamber 12 facing away from the cover plate 4 is provided with an opening. The rotary base 22 and the engaging members 23 extend into the accommodating chamber 12 through the opening, and the motor 21 is connected to the end face of the opening. In this embodiment, the motor 21 may be connected to the end face of the opening by screws.

In this embodiment, the rotary base 22 is connected to an output shaft of the motor 21 by screws, thereby securely connecting the motor 21 to the rotary base 22. The output shaft of the motor 21 is provided with first positioning holes 211, the rotary base 22 is provided with second positioning holes 221, and pins penetrate through the first positioning holes 211 and the second positioning holes 221, thereby improving the assembly precision between the rotary base 22 and the motor 21 and enhancing the assembly reliability of the rotary base 22 and the motor 21. In this embodiment, the rotary base 22 and the motor 21 are positioned by two pins and are detachably connected by six screws.

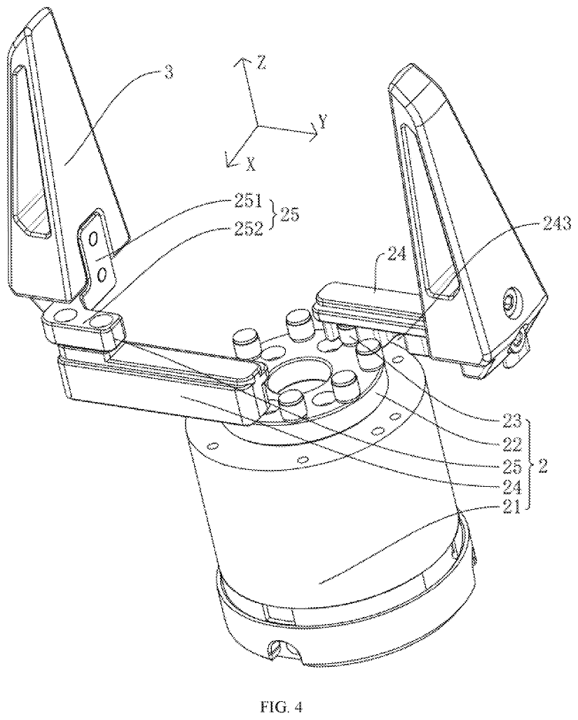

Preferably, as shown in FIGS. 4 and 5, a flange plate 5 is detachably mounted at one end of the motor 21 facing away from the rotary base 22. The flange plate 5 is secured to a tail end of the motor 21 by screws. The flange plate 5 is formed with a hexagonal connecting groove 51 that serves as a universal end-structure interface. The gripper mechanism is connected to the robot arm body through the flange plate 5.

It is to be particularly noted that when the motor 21 rotates, under the condition of constant torque of the motor 21, the distance between the two grippers 3 varies, resulting in different gripping forces of the torque of the motor 21 transmitted to the grippers 3 at different positions. In order to enable the gripper mechanism to grip different objects with a constant force, this embodiment further provides a gripping force control method for the gripper mechanism, which uses the preceding gripper mechanism and includes the steps below.

In S1, a required gripping force for the two grippers 3 is configured.

In S2, a required torque of the motor 21 is calculated by a following formula:

$$A ( α ) = ⌊ ( \frac{N ( α - {α}_{offset} )}{2 π} + \frac{1}{2} ) ⌋$$

$$τ ( α , F ) = FR cos ( \frac{π}{N} - A \times \frac{2 π}{N} + α - {α}_{offset} ) )$$

τ denotes the required torque of the motor 21, F denotes the required gripping force for the grippers 3, R denotes the radius of a circle on which all the engaging members 23 are arranged, A denotes the serial number of an engaging member 23 that drives a rack 24 to move, and α_{offset} denotes an offset radian between a connection line from the axis of a first engaging member 23 to the axis of the motor 21 and the first direction when the grippers 3 are in a closed state. In this embodiment, α_{offset} is 0.1089 rad, and a denotes a rotation radian of the motor 21 relative to α_{offset}. In this embodiment, when the grippers 3 are in the closed state, a is 0, and when the grippers 3 reach the maximum opening distance of 100 mm, a is 2.8155 rad.

In this embodiment, R is a constant; A is a variable, where when the grippers 3 are closed, the serial number of the engaging member 23 that drives the rack 24 to move is 0; α_{offset} is a constant; a is a variable, where the range of a is related to the maximum stroke of the grippers 3.

In S3, the current magnitude of the motor 21 is controlled to enable the motor 21 to reach the required torque.

When the grippers 3 grip the object, the required torque of the motor 21 is calculated according to the rotation radian a of the motor 21 at that time and the required gripping force F, and then the current of the motor 21 is adjusted so that the motor 21 can reach the required torque, thereby ensuring that the grippers 3 can grip objects of different sizes with a constant force and improving the performance of the gripper mechanism. Certainly, in other embodiments, the torque of the motor 21 can be controlled to precisely control any gripping force of the grippers 3.

What is claimed is:

1. A gripper mechanism, comprising:
a securing base, wherein the securing base is provided with two sliding grooves that are spaced apart along a first direction and both extend along a second direction;
a driving assembly, comprising a motor, a rotary base, a plurality of engaging members, and two racks, wherein the motor is configured to drive the rotary base to rotate, the plurality of engaging members are uniformly spaced apart along a circumference on one side of the rotary base facing away from the motor, the two racks are slidably inserted in the two sliding grooves respectively, sides of the two racks facing each other are each provided with a plurality of driving slots spaced apart along the second direction, and at least two of the plurality of engaging members on both sides of the rotary base along the first direction respectively engage with at least two of the plurality of driving slots that are respectively arranged on the two racks; and
two grippers, wherein the two grippers are respectively connected to the two racks to enable the rotary base to drive the two grippers to move toward or away from each other along the second direction when the rotary base rotates.

2. The gripper mechanism according to claim 1, wherein each of the plurality of engaging members is a follower bearing that is detachably connected to the rotary base and is configured to roll on an inner wall of a respective driving slot to be engaged with the respective driving slot.

3. The gripper mechanism according to claim 1, further comprising two adapter blocks, wherein each of the two grippers is connected to a respective rack through a respective adapter block; each of the two adapter blocks comprises a first connecting portion and a second connecting portion that are spaced apart along the first direction, the first connecting portion is connected to a middle position of a respective gripper along the first direction, the second connecting portion is connected to a respective rack, and the two grippers are opposite to each other along the second direction.

4. The gripper mechanism according to claim 3, wherein each of the two racks is provided with a positioning groove, the second connecting portion of each of the two adapter blocks is provided with a positioning protrusion configured to be embedded into a respective positioning groove; or
the second connecting portion of each of the two adapter blocks is provided with a positioning groove, each of the two racks is provided with a positioning protrusion configured to be embedded into a respective positioning groove.

5. The gripper mechanism according to claim 1, further comprising a cover plate, wherein the cover plate is detachably connected to the securing base, a sidewall of each of the two racks is provided with a flange, a bottom of each of the two sliding grooves is provided with a first clearance hole, the cover plate is provided with second clearance holes, and the flange of each of the two racks is located between a bottom of a respective sliding groove and a lower surface of the cover plate; one end of each of the two racks provided with the plurality of driving slots penetrates through a respective first clearance hole, and another end of each of the two racks facing away from the plurality of driving slots penetrates through a respective second clearance hole.

6. The gripper mechanism according to claim 5, wherein one side of the securing base facing away from the cover plate is provided with an accommodating chamber, an end of each of the two racks provided with the plurality of driving slots penetrates through a respective first clearance hole and is located within the accommodating chamber, the rotary base and the plurality of engaging members are located within the accommodating chamber, and the motor is connected to a side of the securing base facing away from the cover plate.

7. The gripper mechanism according to claim 5, wherein the securing base is formed with an edge groove extending along a circumferential direction of the securing base, the cover plate is provided with an edge boss corresponding to the edge groove, and the edge boss is configured to be embedded into the edge groove.

8. The gripper mechanism according to claim 1, wherein a flange plate is detachably mounted at one end of the motor facing away from the rotary base.

9. A robotic arm, comprising a robotic arm body and the gripper mechanism of claim 1, wherein the gripper mechanism is disposed at a tail end of the robotic arm body.

10. The robotic arm according to claim 9, wherein each of the plurality of engaging members is a follower bearing that is detachably connected to the rotary base and is configured to roll on an inner wall of a respective driving slot to be engaged with the respective driving slot.

11. The robotic arm according to claim 9, further comprising two adapter blocks, wherein each of the two grippers is connected to a respective rack through a respective adapter block; each of the two adapter blocks comprises a first connecting portion and a second connecting portion that are spaced apart along the first direction, the first connecting portion is connected to a middle position of a respective gripper along the first direction, the second connecting portion is connected to a respective rack, and the two grippers are opposite to each other along the second direction.

12. The robotic arm according to claim 11, wherein each of the two racks is provided with a positioning groove, the second connecting portion of each of the two adapter blocks is provided with a positioning protrusion configured to be embedded into a respective positioning groove; or
the second connecting portion of each of the two adapter blocks is provided with a positioning groove, each of the two racks is provided with a positioning protrusion configured to be embedded into a respective positioning groove.

13. The robotic arm according to claim 9, wherein the gripper mechanism further comprises a cover plate, wherein the cover plate is detachably connected to the securing base, a sidewall of each of the two racks is provided with a flange, a bottom of each of the two sliding grooves is provided with a first clearance hole, the cover plate is provided with second clearance holes, and the flange of each of the two racks is located between a bottom of a respective sliding groove and a lower surface of the cover plate; one end of each of the two racks provided with the plurality of driving slots penetrates through a respective first clearance hole, and another end of each of the two racks facing away from the plurality of driving slots penetrates through a respective second clearance hole.

14. The robotic arm according to claim 13, wherein one side of the securing base facing away from the cover plate is provided with an accommodating chamber, an end of each of the two racks provided with the plurality of driving slots penetrates through a respective first clearance hole and is located within the accommodating chamber, the rotary base and the plurality of engaging members are located within the accommodating chamber, and the motor is connected to a side of the securing base facing away from the cover plate.

15. The robotic arm according to claim 13, wherein the securing base is formed with an edge groove extending along a circumferential direction of the securing base, the cover plate is provided with an edge boss corresponding to the edge groove, and the edge boss is configured to be embedded into the edge groove.

16. The robotic arm according to claim 9, wherein a flange plate is detachably mounted at one end of the motor facing away from the rotary base.

17. A gripping force control method, using a gripper mechanism, wherein the gripper mechanism comprises:
a securing base, wherein the securing base is provided with two sliding grooves that are spaced apart along a first direction and both extend along a second direction;
a driving assembly, comprising a motor, a rotary base, a plurality of engaging members, and two racks, wherein the motor is configured to drive the rotary base to rotate, the plurality of engaging members are uniformly spaced apart along a circumference on one side of the rotary base facing away from the motor, the two racks are slidably inserted in the two sliding grooves respectively, sides of the two racks facing each other are each provided with a plurality of driving slots spaced apart along the second direction, and at least two of the plurality of engaging members on both sides of the rotary base along the first direction respectively engage with at least two of the plurality of driving slots that are respectively arranged on the two racks; and
two grippers, wherein the two grippers are respectively connected to the two racks to enable the rotary base to drive the two grippers to move toward or away from each other along the second direction when the rotary base rotates;
the gripping force control method comprises following steps:
setting a required gripping force for the two grippers;
calculating a required torque of the motor by a following formula:
$$A ( α ) = ⌊ ( \frac{N ( α - {α}_{offset} )}{2 π} + \frac{1}{2} ) ⌋$$
$$τ ( α , F ) = FR cos ( \frac{π}{N} - A \times \frac{2 π}{N} + α - {α}_{offset} ) )$$
wherein τ denotes the required torque of the motor, F denotes the required gripping force for the two grippers, R denotes a radius of a circle on which the plurality of engaging members are arranged, A denotes a serial number of an engaging member of the plurality of engaging members that drives a rack of the two racks to move, α_{offset} denotes an offset radian between a connection line from an axis of a first engaging member to an axis of the motor and the first direction when the two grippers are in a closed state, and α denotes a rotation radian of the motor relative to α_{offset}; and
controlling a current magnitude of the motor to enable the motor to reach the required torque.

18. The gripping force control method according to claim 17, wherein each of the plurality of engaging members is a follower bearing that is detachably connected to the rotary base and is configured to roll on an inner wall of a respective driving slot to be engaged with the respective driving slot.

19. The gripping force control method according to claim 17, the gripper mechanism further comprises two adapter blocks, wherein each of the two grippers is connected to a respective rack through a respective adapter block; each of the two adapter blocks comprises a first connecting portion and a second connecting portion that are spaced apart along the first direction, the first connecting portion is connected to a middle position of a respective gripper along the first direction, the second connecting portion is connected to a respective rack, and the two grippers are opposite to each other along the second direction.

20. The gripping force control method according to claim 19, wherein each of the two racks is provided with a positioning groove, the second connecting portion of each of the two adapter blocks is provided with a positioning protrusion configured to be embedded into a respective positioning groove; or
the second connecting portion of each of the two adapter blocks is provided with a positioning groove, each of the two racks is provided with a positioning protrusion configured to be embedded into a respective positioning groove.
